(19) United States
(12) Patent Application Publication
(10) Pub. No.: US 2014/0191704 A1
(43) Pub. Date: Jul. 10, 2014

(54) Solar Electric Panel Cellular Phone Charger Hand-Held Computer Charger Lap-Top Computer Charger Electronic Wrist Watch Charger

(71) Applicant: Jimmy Gus Erikson, Stillwater, OK (US)

(72) Inventor: Jimmy Gus Erikson, Stillwater, OK (US)

(73) Assignee: Jimmy Gus Erikson, Stillwater, OK (US)

(21) Appl. No.: 13/736,917

(22) Filed: Jan. 8, 2013

(51) Int. Cl. H02J 7/35; H02J 7/02

(52) U.S. Cl. CPC H02J 7/35; H02J 7/025
USPC 320/101

(57) ABSTRACT

A device to make cellular phone, hand-held computer, lap-top computer, and electric/electronic wrist watch use mote free and convenient comprises a cellular phone, hand held computer, lap-top computer, and electric/electronic wrist watch (FIGS. 1,2,3,4) and an incorporated solar electric panel (10, 20, 30) for providing continuous input electric energy.

Said incorporated solar electric panel, can be fixed (10), detached (20), or pivoting (30).

### BACKGROUND

1. Field of Invention

This invention relates to solar electric panel charging devices incorporated on and with, via electrical connection, electrical and electronic devices, especially to solar electric panel charging devices incorporated on and with electronic cellular phones, hand-held and lap-top computers, and electronic wrist watches.

2. Description of Prior Art

Many, if not all people who utilize electrical and electronic devices which have a limited operation time due to battery operation time or access to an electrical power outlet prefer to not trouble with necessary recharge action and time or being restricted to the availability of an electrical power outlet, if possible. People prefer, if possible, to devote all action and time in the use of an electrical or electronic device to Just that, the use of the device for its primary intended function.

Heretofore much effort has been devoted to developing and producing device batteries which have as long of charge time as possible, and to development and production of recharging devices which function as conveniently as possible. One such device, which is notable, consisted of a solar electric panel incorporated on the outer structure of a hand-held electronic calculator. The solar electric panel was electrically connected to the calculator circuitry, and provided electric power for function and battery recharge. All present batteries and rechargers, however, with regard to cell phones, personal computers, and electronic watches, require the use of an electrical power outlet or battery replacement.

Many companies have manufactured batteries of varying chemical composition, for example alkaline and lithium, in order to increase battery operation time and, therefore, allow for more primary use time of the electric or electronic device in which the battery is placed.

Many companies have also manufactured their own recharging devices, utilizing varying electric circuit designs, with the intent to make recharging as convenient as possible, in order to allow for more primary use time of the electric device to be recharged.

The afore mentioned, however, as previously stated, require the use of an electrical power outlet or battery replacement. Most, if not all, users, therefore, would find it desirable to have a device with little or no recharge time, with little or no recharge requirement (ie. power outlet access), and which did not require battery replacement.

### OBJECTS AND ADVANTAGES

Accordingly we claim the following as our objects and advantages of the invention: to provide a device which combines convenient, continuous electric power input and, in particular, cellular phone use, hand-held and lap-top computer use, and electronic wrist watch use; to provide such a device which allows for, in particular, cellular phone use, hand-held and lap-top computer use, and electronic wrist watch use with a minimum of battery recharge and battery change “down” time; to provide such a device which requires a minimum of skill and training to use; to provide a device which is easily manufactured, incorporating a solar electric panel on the outer structure of a cell phone, hand-held and lap-top computer, and electronic wrist watch; and to provide such a device which, via electric connection (ie. electric wire), combines transfer of sunlight generated electric power, for input, from a detachable solar electric panel placed in a position of optimum exposure to sunlight or electromagnetic radiation and cell phone use, hand-held and lap-top computer use, and electronic wrist watch use.

Readers will find further objects and advantages of the invention from a consideration of the ensuing description and the accompanying drawings.

### DRAWING

### Figures

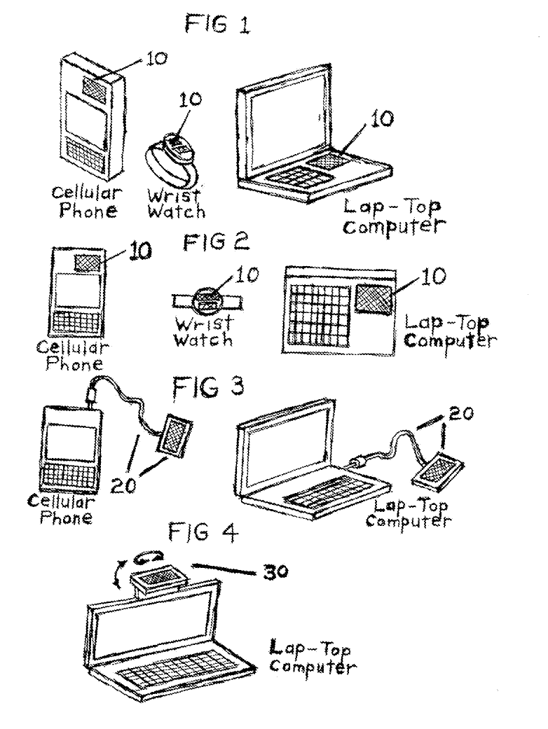

FIG. 1 shows perspective elevation views of variations of the device; with regard to incorporation of a cellular phone, a wrist watch, and a lap-top computer; according to the invention.

FIG. 2 shows top views of variations of the device; with regard to incorporation of a cell phone, a wrist watch, and a tap top computer; according to the invention.

FIG. 3 shows views of variations of the device; utilizing an incorporated electric adaptor, an electric wire, and a solar electric panel; according to other embodiments of the invention.

FIG. 4 shows a view of a variation of the device, where a lap-top computer is incorporated with a pivoting solar electric panel and framework, according to another embodiment of the invention.

### REFERENCE NUMERALS

10 incorporated solar electric panel
20 incorporated electric adaptor, electric wire, and solar electric panel
30 incorporated pivoting solar electric panel and framework

### DEVICE

### Description

FIG. 1 and FIG. 2 show the device according to the preferred embodiments of the invention, the device being represented in its three most pertinent variations or embodiments. The device is comprised of the incorporation of a solar electric panel and/with an electronic device, in particular, a cellular phone, a lap-top computer, and an electronic wrist watch. The solar electric panel is electrically connected to the circuitry of the electronic device, allowing for the transfer of electric input energy from the solar panel to the electronic device.

FIG. 3 and FIG. 4 show three variations. embodiments, of the invention, with regard to the incorporation of the solar electric panel and/with the electronic device. The variations in the placement of the solar electric panel, with regard to Its attachment to the electronic device, are very numerous. The variations in the type/manner of electric connection between the solar electric panel and the electronic device, are very numerous.

### Operation

The devices of FIG. 1 are, with regard to the invention, self-operating. The utilization of the invention requires no additional knowledge or skill other than the prior knowledge and skill required to operate the various electronic devices. The solar panel, obviously, is self-operating.

While the above description contains many specificities, the reader should not construe these as limitations on the scope of the invention, but merely as exemplifications of preferred embodiments thereof. Those skilled in the art will envision many other possible variations are within its scope. For example skilled artisans will readily be able to change the dimensions and shapes of the various embodiments. They will also be able to make the device utilizing different electric/electronic devices. They can make many variations on the means with which to incorporate the solar panel and/with the electric/electronic device. Accordingly the reader is requested to determine the scope of the invention by the appended claims and their legal equivalents, and not by the examples which have been given.

We claim:

1. The incorporation of a solar electric panel with a cellular phone so that said solar electric panel thereof can be used to provide continuous input electric energy to said cellular phone, whereby a human can more freely and conveniently utilize said cellular phone.

2. The incorporation of a solar electric panel with a hand-held computer and a tap-top computer so that said solar electric panel thereof can be used to provide continuous input electric energy to said hand-held computer and said lap-top computer, whereby a human can more freely and conveniently utilize said hand-held computer arid said lap-top computer.

3. The incorporation of a solar electric panel with an electric/electronic wrist watch so that said solar electric panel thereof can be used to provide continuous input electric energy to said electric/electronic wrist watch, whereby a human can more freely and conveniently utilize said electric/electronic wrist watch.

4. The inventions of claim 1 and claim 2 arid claim 3 wherein said incorporation comprises said solar electric panel attached to the outer structure of said cellular phone, hand-held computer, and lap-top computer in a fixed position.

5. The inventions of claim 1 and claim 2 wherein said incorporation comprises said solar electric panel attached to the outer structure of said cellular phone, hand-held computer, and lap-top computer by a pivoting structure.

6. The inventions of claim 1 and claim 2 wherein said incorporation comprises said solar electric panel detached from outer structure of said cellular phone, hand-held computer, and lap-top computer, but electrically connected by electric plug and electric wire, whereby a human can position said solar electric panel for optimum sunlight exposure.
